(19) United States
(12) Patent Application Publication
(10) Pub. No.: US 2021/0032999 A1
(43) Pub. Date: Feb. 4, 2021

(54) INNER BAND FOR TURBINE ENGINE

(71) Applicant: GE Avio S.r.l., Rivalta di Torino (IT)

(72) Inventors: Antonio Giusseppe D'Ettole, Rivoli (IT); Andrea Depalma, Rivalta di Torino (IT); Roberto Maddaleno, Lanzo Torinese (IT); Luca Giacobone, Turin (IT); Matteo Renato Usseglio, Turin (IT)

(21) Appl. No.: 16/935,458

(22) Filed: Jul. 22, 2020

(30) Foreign Application Priority Data
Jul. 29, 2019 (IT) 102019000013218

(51) Int. Cl. F01D 11/12; F01D 5/20

(52) U.S. Cl. CPC F01D 11/122; F01D 5/20; F05D 2260/36; F05D 2240/14; F05D 2240/307

(57) ABSTRACT

A turbine engine with an outer rotor that circumscribes an inner rotor or inner stator. The outer rotor includes circumferentially arranged components with a tip and a root. The root of each of the circumferentially arranged components can terminate at an inner platform, where the collection of inner platforms can define an inner band.

### CROSS-REFERENCE TO RELATED APPLICATION(S)

This application claims priority to Italian Application No. 102019000013218, filed Jul. 29, 2019, which is incorporated herein by reference its entirety.

The project leading to this application has received funding from the Clean Sky 2 Joint Undertaking under the European Union's Horizon 2020 research and innovation program under grant agreement No. CS2-LPA-GAM-2018/2019-01.

### TECHNICAL FIELD

This disclosure generally relates to a turbine engine with an outer rotor that rotates about one of an inner rotor or inner stator and more specifically relates to at least one circumferentially arranged blade assembly coupled to the outer rotor.

### BACKGROUND

Turbine engines, and particularly gas or combustion turbine engines, are rotary engines that extract energy from a flow of combusted gases passing through the engine onto a multitude of rotating turbine blades.

A turbine engine includes but is not limited to, in serial flow arrangement, a forward fan assembly, an aft fan assembly, a high-pressure compressor for compressing air flowing through the engine, a combustor for mixing fuel with the compressed air such that the mixture may be ignited, and a high-pressure turbine. The high-pressure compressor, combustor and high-pressure turbine are sometimes collectively referred to as the core engine. In operation, the core engine generates combustion gases which are discharged downstream to a counter-rotating low-pressure turbine that extracts energy therefrom for powering the forward and aft fan assemblies.

In at least some turbine engines, at least one turbine rotates in an opposite direction than the other rotating components within the engine. In some implementations a counter-rotating low-pressure turbine includes an outer drum having a first set of stages that are rotatably coupled to the forward fan assembly, and an inner drum having an equal number of stages that is rotatably coupled to the aft fan assembly.

Counter rotating blades present challenges and a need for better sealing between the counter rotating portions. For example, improved sealing and design is needed at the inner platform of the outer rotor blades.

### BRIEF DESCRIPTION

In one aspect, the present disclosure relates to a turbine engine that includes an inner rotor/stator having a longitudinal axis and an outer rotor circumscribing at least a portion of the inner rotor/stator and rotating about the longitudinal axis, and includes a drum, and a plurality of circumferentially arranged blade assemblies each comprising a blade terminating at a tip in an outer platform, and terminating at a root in an inner platform, with the outer platforms collectively defining an outer band secured to the drum, the inner platforms collectively forming an inner band, and with the inner platform having at least one of: a double-tail trailing edge defining a buffer cavity, a box beam cross section, or a stepped lower surface.

### BRIEF DESCRIPTION OF THE DRAWINGS

In the drawings:

FIG. 1 is a schematic cross-sectional diagram of a turbine engine with an outer rotor and at least one of an inner rotor or stator.

FIG. 2 is a schematic view of a portion of an outer rotor, an inner rotor/stator, and respective blades of the counter rotating low pressure turbine of FIG. 1.

FIG. 3 is a schematic cross-sectional view of a portion of the inner band of the blades of FIG. 2.

FIG. 4 is a variation of the schematic cross-sectional view of FIG. 3.

FIG. 5 is another variation of the schematic cross-sectional view of FIG. 3.

FIG. 6 is yet another variation of the schematic cross-sectional view of FIG. 3.

FIG. 7 is still yet another variation of the schematic cross-sectional view of FIG. 3.

FIG. 8 is another variation of the schematic cross-sectional view of FIG. 3.

FIG. 9 is another variation of the schematic cross-sectional view of FIG. 3.

FIG. 10 is another variation of the schematic cross-sectional view of FIG. 3.

FIG. 11 is another variation of the schematic cross-sectional view of FIG. 3.

FIG. 12 is another variation of the schematic cross-sectional view of FIG. 3.

FIG. 13 is another variation of the schematic cross-sectional view of FIG. 3.

### DETAILED DESCRIPTION

Aspects of the disclosure described herein are directed to a turbine engine with an inner band of circumferentially arranged components coupled to an outer rotor, where the outer rotor circumscribes an inner rotor/stator. For purposes of illustration, the present disclosure will be described with respect to a counter rotating low pressure turbine for an aircraft turbine engine. It will be understood, however, that aspects of the disclosure described herein are not so limited and may have general applicability within other engines, including, but not limited to, low pressure turbines with stationary stator components or counter-rotating portions of the engine located in positions other than the low pressure turbine portion. For example, the disclosure can have applicability in other vehicles or engines, and can be used to provide benefits in industrial, commercial, and residential applications.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, fore/forward can mean upstream and aft/rearward can mean downstream.

Additionally, as used herein, the terms “radial” or “radially” refer to a direction away from a common center. For example, in the overall context of a turbine engine, radial refers to a direction along a ray extending between a center longitudinal axis of the engine and an outer engine circumference. Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, secured, fastened, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

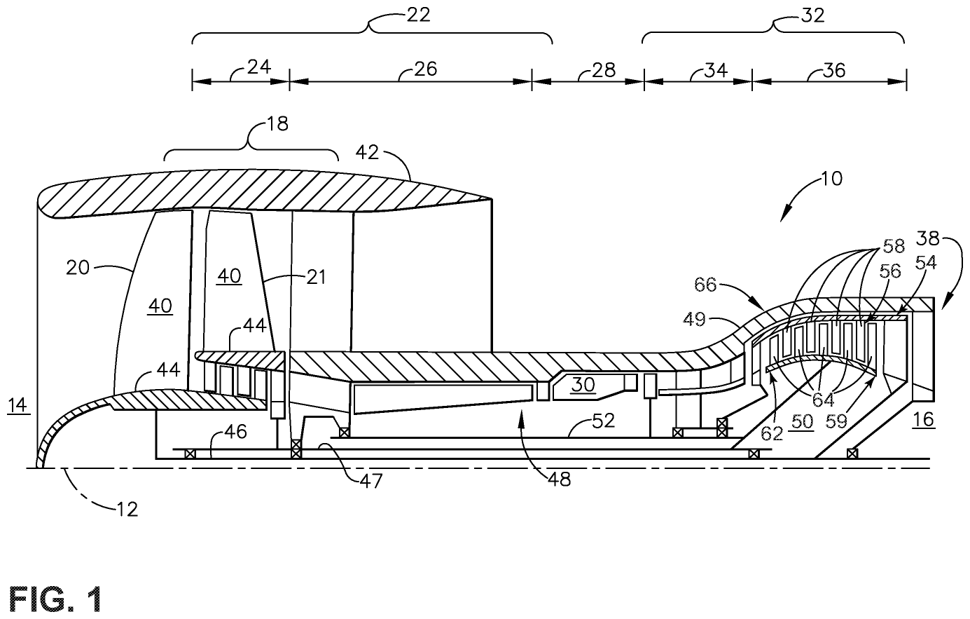

FIG. 1 is a schematic cross-sectional diagram of a turbine engine 10 for an aircraft. The turbine engine 10 has a centerline or longitudinal axis 12 extending forward 14 to aft 16. The turbine engine 10 includes, in downstream serial flow relationship, a fan section 18 including a forward fan assembly 20 and an aft fan assembly 21, a compressor section 22 including a booster or low pressure (LP) compressor 24 and a high pressure (HP) compressor 26, a combustion section 28 including a combustor 30, a turbine section 32 including a HP turbine 34, and a counter-rotating LP turbine 36, and an exhaust section 38.

The fan assemblies 20 and 21 are positioned at a forward end of the turbine engine 10 as illustrated. The terms “forward fan” and “aft fan” are used herein to indicate that one of the fans 20 is coupled axially upstream from the other fan 21. It is also contemplated that the fan assemblies 20, 21 can be positioned at an aft end of turbine engine 10. Fan assemblies 20 and 21 each include a plurality of rows of fan blades 40 positioned within a fan casing 42. The fan blades 40 are joined to respective rotor disks 44 that are rotatably coupled through a respective forward fan shaft 46 to the forward fan assembly 20 and through an aft fan shaft 47 to the aft fan assembly 21.

The HP compressor 26, the combustor 30, and the HP turbine 34 form an engine core 48 of the turbine engine 10. The engine core 48 is surrounded by a shroud or outer casing 49 defining an interior 50, which can be coupled with the fan casing 42. The HP turbine 34 is coupled to the HP compressor 26 via a core rotor or shaft 52. In operation, the engine core 48 generates combustion gases that are channeled downstream to the counter-rotating LP turbine 36 which extracts energy from the gases for powering fan assemblies 20, 21 through their respective fan shafts 46, 47.

The counter-rotating LP turbine 36 includes an outer rotor 54 positioned radially inward from outer casing 49. The outer rotor 54 can include at least one component that includes a plurality of circumferentially arranged component segments, illustrated by example as a first set of airfoils 56 comprised of a plurality of circumferentially arranged airfoils 58 that extend radially inwardly from the outer rotor 54 towards the longitudinal axis 12. The first set of airfoils 56 can be a first set of rotating blades comprised of a plurality of circumferentially arranged blades. Alternatively, the first set of airfoils 56 can be circumferentially arranged stationary blades or vanes, where a pair of stationary blades or vanes can form a nozzle.

The counter-rotating LP turbine 36 further includes an inner rotor/stator 59 that is at least in part circumscribed by the outer rotor 54. The inner rotor/stator 59 can be stationary or rotate depending on the particular engine configuration. As illustrated by way of example, the inner rotor/stator 59 is arranged substantially coaxially with respect to, and radially inward of the outer rotor 54. The inner rotor/stator 59 includes a second set of airfoils 62 with airfoils 64, circumferentially arranged, where each airfoil 64 extends radially outwardly away from the longitudinal axis 12. The second set of airfoils 62 can be a first set of rotating blades comprised of a plurality of circumferentially arranged blades. Alternatively, the second set of airfoils 62 can be stationary blades or vanes, where a pair of stationary blades or vanes can form a nozzle.

The first and second sets of airfoils 56, 62 define a plurality of turbine stages 66. While illustrated as having five stages, it should be understood that any quantity of stages is contemplated and the stages shown are for illustrative purposes and not meant to be limiting.

While illustrated as having a counter-rotating LP turbine 36, it should be understood that aspects of the disclosure discussed herein can be applied to turbine engines without counter-rotating LP turbines. Turbine engines having LP turbines in which static circumferentially arranged vanes are axially spaced from rotating circumferentially arranged blades are also contemplated. Furthermore, it is also contemplated that portions of the fan section 18, the compressor section 22, in particular either the LP compressor 24 or the HP compressor 26 of the turbine engine 10, can counter-rotate.

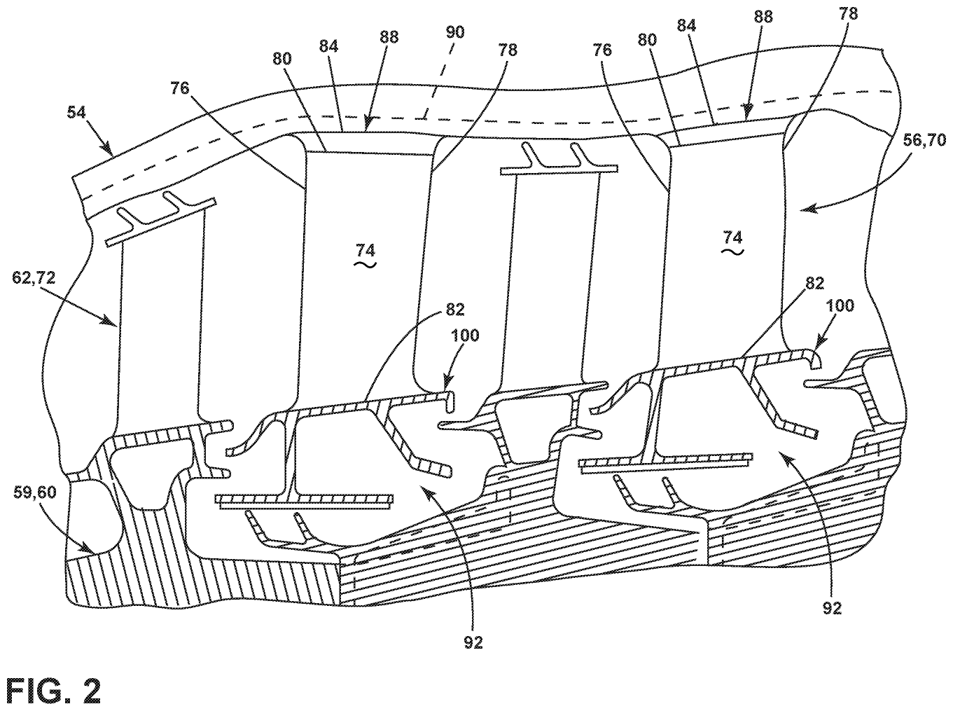

FIG. 2 further illustrates the outer rotor 54, the inner rotor/stator 59, and the first and second sets of airfoils 56, 62 from the turbine engine 10. In the example shown, the inner rotor/stator 59 is illustrated as an inner rotor 60 where the outer rotor 54 and the inner rotor 60 counter rotate. The first and second sets of airfoils 56, 62 are illustrated as first and second sets of blades 70, 72, however it will be understood that the first and second sets of airfoils 56, 62 can include any suitable stationary or non-stationary airfoil in the turbine engine 10, including in the fan section 18, compressor section 22, or turbine section 32.

The first set of blades 70 couple to the outer rotor 54 and the second set of blades 72 couple to the inner rotor 60. The first and second sets of blades 70, 72 can include a plurality of circumferentially arranged blade assemblies.

Each blade assembly or blade 74 of the first set of blades 70 can have a leading edge 76, a trailing edge 78, a tip 80 and a root 82. The tip 80 of each blade 74 terminates in an outer platform 84. That is, the tip 80 can couple to or be received by the outer platform 84. Similarly, an inner platform 100 can receive or couple to the root 82, such that the root 82 of the blade 74 terminates in the inner platform 100.

An outer band 88 can be defined by a circumferential arrangement of the outer platforms 84 of each of the plurality of circumferentially arranged blade assemblies of the first set of blades 70. The outer band 88 of each of the plurality of circumferentially arranged blade assemblies secures to an outer annular housing, shroud or similar structure, which can be thought of as an open-ended barrel or a drum 90. The outer band 88 can be a portion or component of the drum 90. That is, the outer band 88 can be formed as part of the drum 90 or coupled to the drum 90. The drum 90 can be a portion or component of the outer rotor 54. The drum 90 can be formed as part of the outer rotor 54 or coupled to the outer rotor 54.

An inner band 92 can be defined by the collection of the inner platforms 100 of each set of circumferentially arranged blades of the first set of blades 70. While the plurality of blade assemblies of the first set of blades 70 are illustrated as having similar structure, it is contemplated that each blade 74 can include, for example, different inner platforms, outer platforms, blade shapes or size.

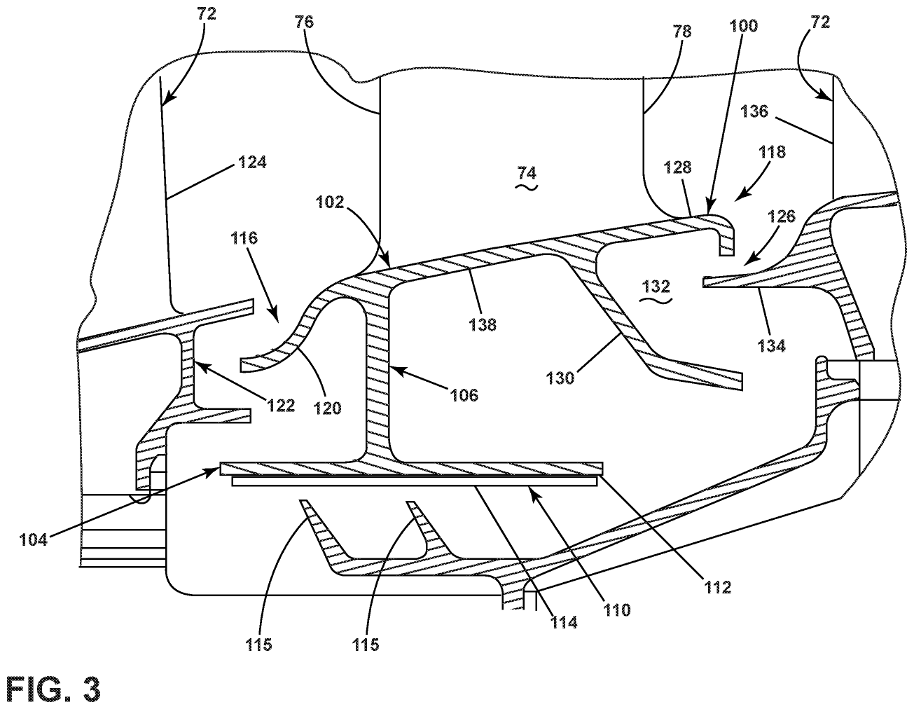

Turning to FIG. 3 the inner platform 100 has an upper ledge 102, supporting the blade 74, and a lower ledge 104 spaced from and connected to upper ledge 102 by at least one connecting rib 106.

An abradable element 110 can be carried or supported by the inner platform 100. For example, the lower ledge 104 can include a seat 112 to which the abradable element 110 can be fixed. The abradable element 110 can be any material or combination of materials that degrades or wears under contact or pressure from a second element, while preserving the second element. As used herein, the term abradable element will be any material or coating that, when rubbed by another object, the abradable element will wear or abrade, whereas the object in motion will experience little to no wear or abrasion. By way of non-limiting example, the abradable element 110 can include a honeycomb element 114. At least one finger seal 115 can confront the abradable element 110 or the honeycomb element 114.

The upper ledge 102 has a leading edge portion 116 and a trailing edge portion 118. A leading edge finger 120 can extend from the leading edge portion 116 of the upper ledge 102. While all shapes, sizes, contours, and number of leading edge fingers have been considered, the leading edge finger 120 is illustrated, by way of example, as having a radially inward curve. Optionally, the leading edge finger 120 can extend into a receiving portion 122 of an adjacent blade 124 from the second set of blades 72, that is, the leading edge finger 120 can radially or axially overlap a portion of the adjacent blade 124.

A double-tail trailing edge 126 is formed at the trailing edge portion 118 of the inner platform 100. The double-tail trailing edge 126 includes first and second spaced fingers 128, 130. Optionally, the trailing edge portion 118 can form a portion of the first finger 128. Spaced from the first finger 128, the second finger 130 can extend away from the trailing edge portion 118 of the upper ledge 102. For example, the second finger 130 can extend axially and radially downward from the trailing edge portion 118. It is contemplated that the at least one finger seal 115, the leading edge finger 120, or the first and second fingers 128, 130 can include at least one bend.

A buffer cavity 132 is at least partially defined by the first and second spaced fingers 128, 130. Optionally, a protruding portion 134 of another adjacent blade 136 from the second set of blades 72 can radially or axially extend into or be received by the buffer cavity 132.

A connecting portion 138 can form at least a portion of the upper ledge 102. The connecting portion 138 can connect the first finger 128 and the leading edge finger 120. It is contemplated that the connecting portion 138 can be linear or non-linear, such that the connecting portion 138 is a straight portion or a curved portion of the upper ledge 102 connecting the first finger 128 and the leading edge finger 120.

In operation, the first set of blades 70 coupled to the outer rotor 54 via outer platforms 84 rotate about the longitudinal axis 12. The root 82 of each blade 74 of the first set of blades 70 terminates radially inward at the inner platform 100. The structure of the inner platform 100 helps to maintain the radial and axial alignment or position of the first set of blades 70 as they rotate. It is contemplated that the inner platform 100 also provides radial and axial alignment for the second set of blades 72 that can be counter-rotating with respect to the first set of blades 70.

For example, the leading edge finger 120 of the blade 74 penetrates the receiving portion 122 of the adjacent blade 124 to provide radial or axial support. Similarly, the protruding portion 134 of the another adjacent blade 136 can be received by the buffer cavity 132 of the blade 74 to provide radial or axial support.

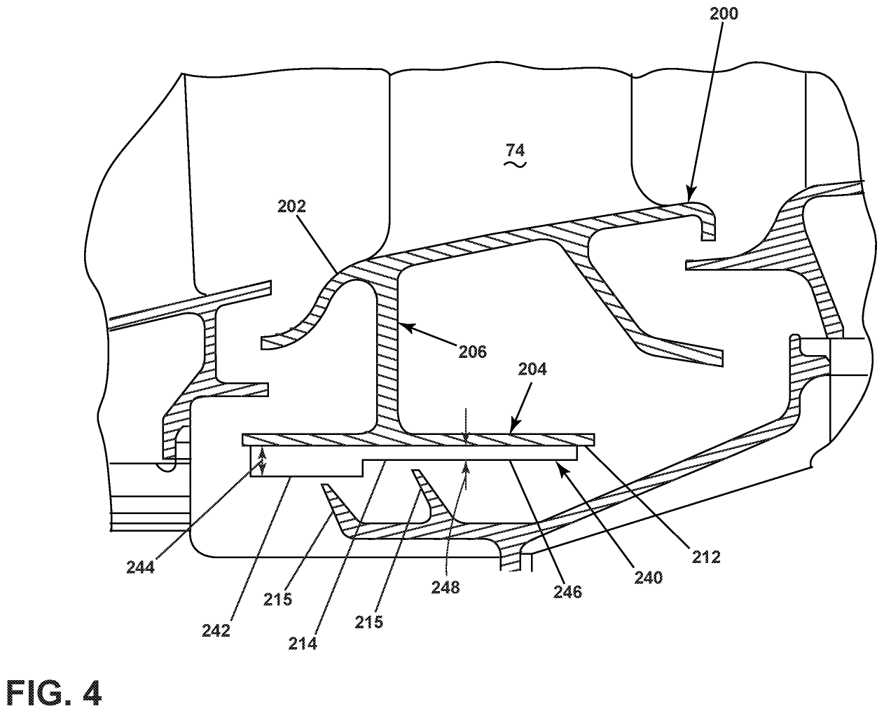

FIG. 4 is another example of an inner platform 200 coupled to the blade 74. The inner platform 200 is similar to the inner platform 100, therefore, like parts will be identified with like numerals increased by 100, with it being understood that the description of the like parts of the inner platform 100 applies to the inner platform 200, unless otherwise noted.

The inner platform 200 has an upper ledge 202, supporting the blade 74, and a lower ledge 204 spaced from and connected to upper ledge 202 by at least one connecting rib 206.

An abradable element 240 can be carried or supported by the inner platform 200. For example, the lower ledge 204 can include a seat 212 to which the abradable element 240 can be fixed. The amount of abradable material forming the abradable element 240 can vary in thickness or composition. A first abradable portion 242 can extend a first distance 244 radially inward from the seat 212. A second abradable portion 246 can extend a second distance 248 radially inward from the seat 212. The first distance 244 can be greater than the second distance 248, as illustrated by the first abradable portion 242 extending radially away from the seat 212 farther than the second abradable portion 246. The first and second abradable portions 242, 246 can form steps, as illustrated. Finger seals 215 can confront the abradable element 240. The finger seals 215 can have varying lengths and thicknesses to accommodate the stepped or contoured first or second abradable portions 242, 246.

It is contemplated that the second distance 248 can be greater than the first distance 244. It is further contemplated that any number of abradable portions extending different or similar distances from the seat 212 can be used or combined to form the abradable element 240.

The abradable element 240 can be any material or combination of materials that degrades or wears under contact or pressure from another element, while preserving the other element. By way of non-limiting example, the abradable element can include a honeycomb element 214.

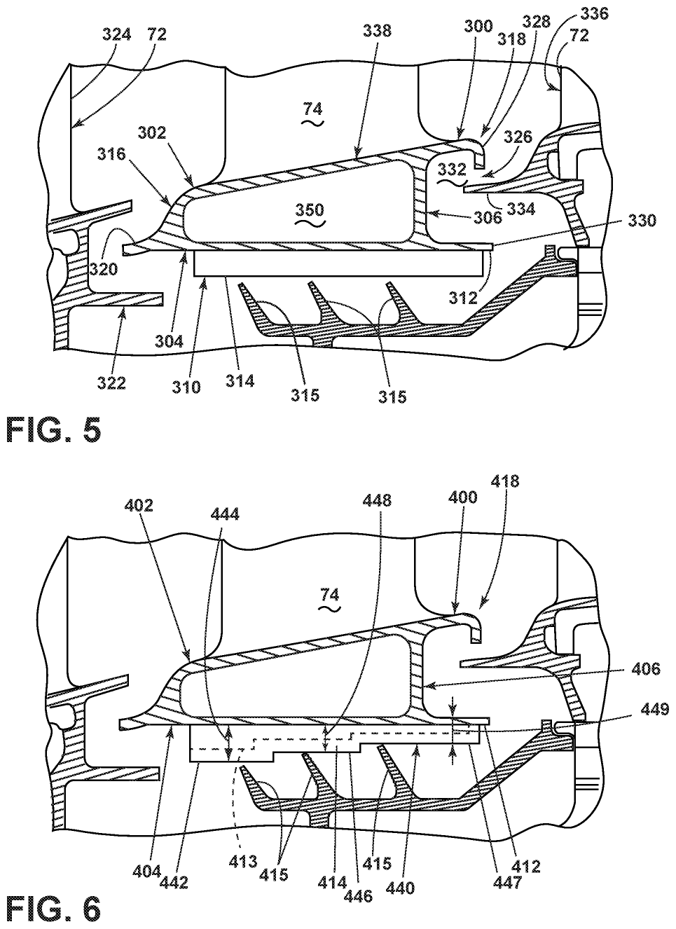

FIG. 5 is another example of an inner platform 300 coupled to the blade 74. The inner platform 300 is similar to the inner platform 100, 200, therefore, like parts will be identified with like numerals further increased by 100, with it being understood that the description of the like parts of the inner platform 100, 200 applies to the inner platform 300, unless otherwise noted.

The inner platform 300 has an upper ledge 302, supporting the blade 74, and a lower ledge 304 spaced from and connected to upper ledge 302 by at least one connecting rib 306. A leading edge 316 can be defined by the merger of the upper ledge 302 and the lower ledge 304. A double-tail trailing edge 326 can be defined by divergence of the upper ledge 302 and lower ledges 304.

An abradable element 310 can be carried or supported by the inner platform 300. For example, the lower ledge 304 can include a seat 312 to which the abradable element 310 can be fixed. The abradable element 310 can be any material or combination of materials that degrades or wears under contact or pressure from a second element, while preserving the second element. By way of non-limiting example the abradable element 310 can include a honeycomb element 314. At least one finger seal 315 can confront the abradable element 310 or the honeycomb element 314.

A leading edge finger 320 can extend from the leading edge portion 316. While all shapes, sizes, contours, and number of leading edge fingers have been considered, the leading edge finger 320 is illustrated, by way of example, as having a radially inward curve. Optionally, the leading edge finger 320 can extend into a receiving portion 322 of an adjacent blade 324 from the second set of blades 72, that is, the leading edge finger 320 can radially or axially overlap a portion of the adjacent blade 324.

The double-tail trailing edge 326 includes first and second spaced fingers 328, 330. A trailing edge portion 318 of the upper ledge 302 can form a portion of the first finger 328. Spaced from the first finger 328, the second finger 330 can be formed, in part, by the lower ledge 304.

A buffer cavity 332 is defined by the first and second spaced fingers 328, 330. Optionally, a protruding portion 334 of another adjacent blade 336 from the second set of blades 72 can radially or axially extend into or be received by the buffer cavity 332.

A connecting portion 338 can form at least a portion of the upper ledge 302. The connecting portion 338 can connect the first finger 328 and the leading edge finger 320. It is contemplated that the connecting portion 338 can be linear or non-linear, such that the connecting portion 338 with a straight portion or a curved portion defines a part of the upper ledge 302 and connects the first finger 328 and the leading edge finger 320.

A box 350 can be defined by the upper ledge 302, the connecting rib 306, the lower ledge 304, and the leading edge 316 where the upper and lower ledges 302, 304 converge. The box 350 with the connecting rib 306 can be considered to have a box beam cross section where the connecting rib 306 provides a beam adjacent to the box 350.

FIG. 6 is yet another example of an inner platform 400 coupled to the blade 74. The inner platform 400 is similar to the inner platform 100, 200, 300 therefore, like parts will be identified with like numerals further increased by 100, with it being understood that the description of the like parts of the inner platform 100, 200, 300 applies to the inner platform 400, unless otherwise noted.

The inner platform 400 has an upper ledge 402, supporting the blade 74, and a lower ledge 404 spaced from and connected to upper ledge 402 by at least one connecting rib 406.

An abradable element 440 can be carried or supported by the inner platform 400. For example, the lower ledge 404 can include a seat 412 to which the abradable element 440 can be fixed. The amount of abradable material forming the abradable element 440 can vary in thickness or composition. A first abradable portion 442 can extend a first distance 444 radially inward from the seat 412. A second abradable portion 446 can extend a second distance 448 radially inward from the seat 412. A third abradable portion 447 can extend a third distance 449 radially inward from the seat 412.

The first distance 444 can be greater than the second distance 448 or the third distance 449. The second distance 448 can be greater than the third distance 449. As illustrated by the first, second, and third abradable portions 442, 446, 447 extend radially away from the seat 412 forming steps. Finger seals 415 can confront the abradable element 440. The finger seals 415 can have varying lengths and thicknesses to accommodate the stepped or contoured shape of the first, second, or third abradable portions 442, 446, 447.

It is contemplated that the ranking or length of the first, second, and third distances 444, 448, 449, can be different than what is illustrated. It is further contemplated that any number of abradable portions extending different or similar distances from the seat 412 can be used or combined to form the abradable element 440.

The abradable element 440 can be any material or combination of materials that degrades or wears under contact or pressure from another element, while preserving the other element. By way of non-limiting example, the abradable element can include a honeycomb element 414.

Alternatively, the seat 412 or the lower ledge 404 can be stepped. A stepped lower surface 413 can be defined by the at least one step spaced from a trailing edge portion 418, the seat 412 having a stepped shape, or the lower ledge 404 having a stepped shape. It is contemplated that additional elements can be combined with the lower ledge 404 of varying radial thicknesses or distances to create the stepped lower surface 413. It is further contemplated that the step can be multiple steps, where the multiple steps can be radially spaced.

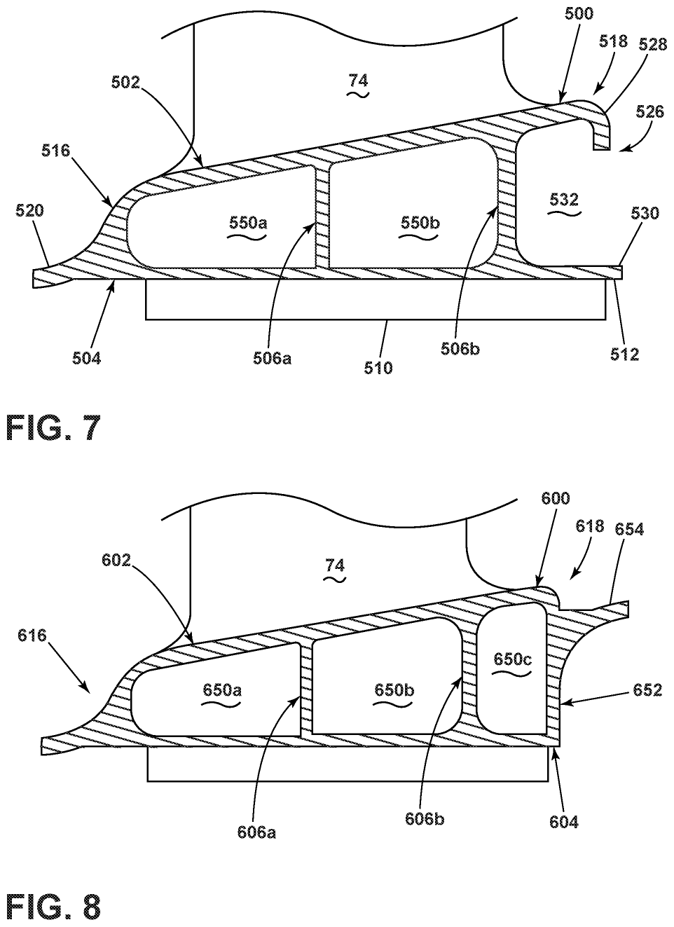

FIG. 7 is still yet another example of an inner platform 500 coupled to the blade 74. The inner platform 500 is similar to the inner platform 100, 200, 300, 400, therefore, like parts will be identified with like numerals further increased by 100, with it being understood that the description of the like parts of the inner platform 100, 200, 300, 400 applies to the inner platform 500, unless otherwise noted.

The inner platform 500 has an upper ledge 502, supporting the blade 74, and a lower ledge 504 spaced from and connected to upper ledge 502 by multiple connecting ribs to define multiple boxes. By way of example, the multiple connecting ribs are illustrated as first and second ribs 506a, 506b and the multiple boxes are illustrated as first and second boxes 550a, 550b.

A leading edge 516 can be defined by the merger of the upper ledge 502 and the lower ledge 504. The first box 550a can be defined by the upper ledge 502, the first rib 506a, the lower ledge 504, and the leading edge 516 where the upper and lower ledges 502, 504 converge. The second box 550b can be defined by the upper ledge 502, the lower ledge 504, and the first and second ribs 506a, 506b. The first and second boxes 550a, 550b are defined in part by the first or second ribs 506a, 500b and can be considered to have a box beam cross section where the first or second ribs 506a, 506b provides a beam adjacent to define the first and second boxes 550a, 550b. The first and second boxes 550a, 550b, by way of non-limiting example, can be axially arranged in the inner platform 500 between the upper and lower ledges 502, 504.

A double-tail trailing edge 526 can be defined by divergence of the upper ledge 502 and lower ledges 504. The double-tail trailing edge 526 includes first and second spaced fingers 528, 530. A trailing edge portion 518 of the upper ledge 502 can form a portion of the first finger 528. Spaced from the first finger 528, the second finger 530 can be formed, in part, by the lower ledge 504. A buffer cavity 532 is defined by the first and second spaced fingers 528, 530.

An abradable element 510 can be carried or coupled to the inner platform 500. A seat 512 can be provided by the lower ledge 504 that can connect the abradable element 510 to the inner platform 500.

FIG. 8 is another example of an inner platform 600 coupled to the blade 74. The inner platform 600 is similar to the inner platform 100, 200, 300, 400, 500, therefore, like parts will be identified with like numerals further increased by 100, with it being understood that the description of the like parts of the inner platform 100, 200, 300, 400, 500 applies to the inner platform 600, unless otherwise noted.

The inner platform 600 has an upper ledge 602, supporting the blade 74, and a lower ledge 604 spaced from and connected to upper ledge 602 by multiple connecting ribs to define multiple boxes. By way of example, the multiple connecting ribs are illustrated as first and second ribs 606a, 606b and the multiple boxes are illustrated as first and second boxes 650a, 650b.

A leading edge 616 can be defined by the merger of the upper ledge 602 and the lower ledge 604. The first box 650a can be defined by the upper ledge 602, the first rib 606a, the lower ledge 604, and the leading edge 616 where the upper and lower ledges 602, 604 converge. The second box 650b can be defined by the upper ledge 602, the lower ledge 604, and the first and second ribs 606a, 606b. The first and second boxes 650a, 650b are defined in part by the first or second ribs 606a, 600b and can be considered to have a box beam cross section where the first or second ribs 606a, 606b provides a beam adjacent to the first and second boxes 650a, 650b.

A trailing edge portion 618 of the inner platform 600 can include a beam 652 connecting terminating ends or trailing edge portions of the upper and lower ledges 602, 604. A trailing finger 654 can couple to the beam 652 and extend away from the inner platform 600. A third box 650c can be defined by the upper ledge 602, the lower ledge 604, the second rib 606b, and the beam 652. The third box 650c can be considered to have a box beam cross section.

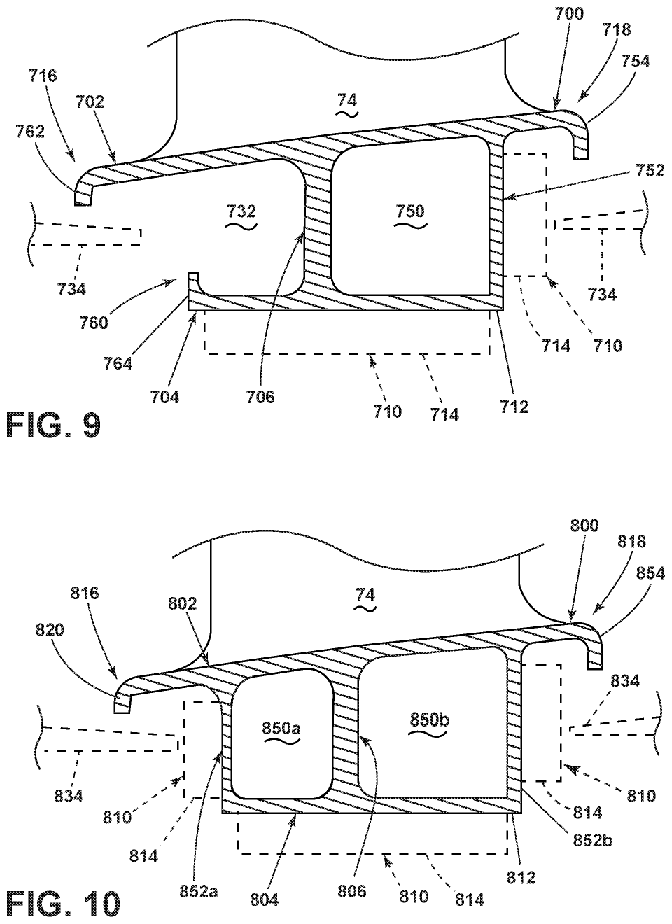

FIG. 9 is another example of an inner platform 700 coupled to the blade 74. The inner platform 700 is similar to the inner platform 100, 200, 300, 400, 500, 600 therefore, like parts will be identified with like numerals further increased by 100, with it being understood that the description of the like parts of the inner platform 100, 200, 300, 400, 500, 600 applies to the inner platform 700, unless otherwise noted.

The inner platform 700 has an upper ledge 702, supporting the blade 74, and a lower ledge 704 spaced from and connected to upper ledge 702 by at least one connecting rib 706. The inner platform 700 has a leading edge portion 716 and a trailing edge portion 718.

A double-tail leading edge 760 is formed at the leading edge portion 718 of the inner platform 700. The double-tail leading edge 760 includes first and second spaced fingers 762, 764. The first finger 762 can be formed in part by the upper ledge 702, while the second finger 764 can be formed in part by the lower ledge 704. A buffer cavity 732 is defined by the first and second spaced fingers 762, 764. Optionally, a protruding portion 734 can radially or axially extend into or be received by the buffer cavity 732.

A trailing finger 754 can extend from the trailing edge portion 718 of the upper ledge 702. Optionally, the trailing finger 754 can radially or axially overlap a protruding portion 734 of an adjacent blade.

The trailing edge portion 718 can include a beam 752 connecting the upper and lower ledges 702, 704. A box 750 can be defined by the upper ledge 702, the lower ledge 704, the connecting rib 706, and the beam 752. The box 750 can be considered to have a box beam cross section.

At least one abradable element 710 can be carried or supported by the inner platform 700. For example, the lower ledge 704 can include a seat 712 to which the at least one abradable element 710 can be fixed. Additionally, or alternatively, the beam 752 can carry the at least one abradable element 710. By way of non-limiting example the at least one abradable element 710 can include a honeycomb element 714.

FIG. 10 is another example of an inner platform 800 coupled to the blade 74. The inner platform 800 is similar to the inner platform 100, 200, 300, 400, 500, 600, 700 therefore, like parts will be identified with like numerals further increased by 100, with it being understood that the description of the like parts of the inner platform 100, 200, 300, 400, 500, 600, 700 applies to the inner platform 800, unless otherwise noted.

The inner platform 800 has an upper ledge 802, supporting the blade 74, and a lower ledge 804 spaced from and connected to upper ledge 802 by at least one connecting rib 806. The inner platform 800 has a leading edge portion 816 and a trailing edge portion 818.

A leading edge finger 820 can extend from the leading edge portion 816 of the upper ledge 802. Optionally, the leading edge finger 820 can radially or axially overlap a protruding portion 834 of an adjacent blade.

The leading edge portion 816 of the inner platform 800 or lower ledge 804 can include a first beam 852a connecting the upper and lower ledges 802, 804. A first box 850a can be defined by the upper ledge 802, the lower ledge 804, the connecting rib 806, and the first beam 852a.

A trailing finger 854 can extend from the trailing edge portion 818 of the upper ledge 802. Optionally, the trailing finger 854 can radially or axially overlap a protruding portion 834 of an adjacent blade. A second beam 852b can connect the upper and lower ledges 802, 804 at the trailing edge portion 818 of the inner platform 800 or lower ledge 804. A second box 850b can be defined by the upper ledge 802, the lower ledge 804, the connecting rib 806, and the second beam 852b. The first and second boxes 850a, 850b can be considered to have a box beam cross section. It is contemplated that any number of beams or ribs can provide multiple boxes arranged between the upper ledge 802 and lower ledge 804.

At least one abradable element 810 can be carried or supported by the inner platform 800. For example, the lower ledge 804 can include a seat 812 to which the at least one abradable element 810 can be fixed. Additionally, or alternatively, the first beam 852a or the second beam 852b can carry the at least one abradable element 810. By way of non-limiting example the abradable element 810 can include a honeycomb element 814.

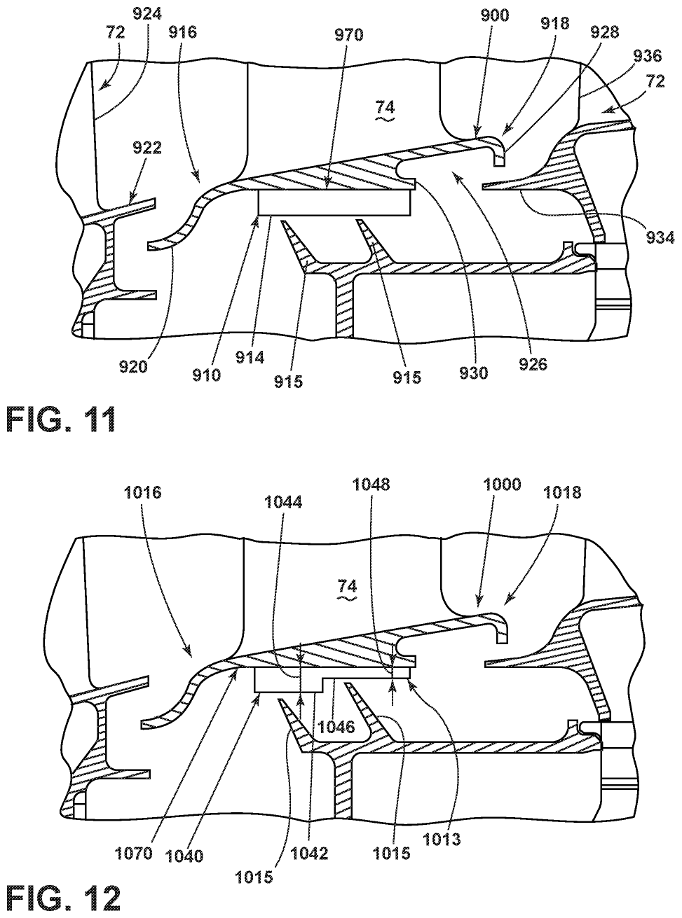

FIG. 11 is another example of an inner platform 900 coupled to the blade 74. The inner platform 900 is similar to the inner platform 100, 200, 300, 400, 500, 600, 700, 800 therefore, like parts will be identified with like numerals further increased by 100, with it being understood that the description of the like parts of the inner platform 100, 200, 300, 400, 500, 600, 700, 800 applies to the inner platform 900, unless otherwise noted.

The inner platform 900 has a leading edge portion 916, a trailing edge portion 918, and a step 970 spaced from the trailing edge portion 918 of the inner platform 900.

A leading edge finger 920 can extend from the leading edge portion 916 of the inner platform 900. While all shapes, sizes, contours, and number of leading edge fingers have been considered, the leading edge finger 920 is illustrated, by way of example, as having a radially inward curve. Optionally, the leading edge finger 920 can extend into a receiving portion 922 of an adjacent blade 924 from the second set of blades 72, that is, the leading edge finger 920 can radially or axially overlap a portion of the adjacent blade 924.

A double-tail trailing edge 926 includes first and second spaced fingers 928, 930. A trailing edge portion 918 of the inner platform 900 can form a portion of the first finger 928. Spaced from the first finger 928, the second finger 930 can be formed, in part, by the step 970. Optionally, a least the first or second fingers 928, 930 can radially extend past a protruding portion 934 of another adjacent blade 936 from the second set of blades 72.

An abradable element 910 can be carried or supported by the step 970. By way of non-limiting example the abradable element 910 can include a honeycomb element 914. At least one finger seal 915 can confront the abradable element 910 or the honeycomb element 914.

The inner platform 900 does not include an upper or lower ledge. The effect of this structure is that the radial size of the inner platform 900 is smaller. This radial size difference can create a larger gab between the finger seals 915 and the abradable element 910. It is contemplated that the finger seals 915 can include a radially longer design to make up the distance between the finger seals 915 and the abradable element 910 to ensure a seal. Additionally, or alternatively, the finger seals 915 can be structurally positioned closer to the abradable element 910 of the inner platform 900 to ensure proper sealing.

FIG. 12 is another example of an inner platform 1000 coupled to the blade 74. The inner platform 900 is similar to the inner platform 100, 200, 300, 400, 500, 600, 700, 800, 900 therefore, like parts will be identified with like numerals further increased by 100, with it being understood that the description of the like parts of the inner platform 100, 200, 300, 400, 500, 600, 700, 800, 900 applies to the inner platform 1000, unless otherwise noted.

The inner platform 1000 has a leading edge portion 1016, a trailing edge portion 1018, and a step 1070 spaced from the trailing edge portion 1018 of the inner platform 1000.

An abradable element 1040 can be carried by or mounted to the step 1070. A first abradable portion 1042 can extend a first distance 1044 radially inward. A second abradable portion 1046 can extend a second distance 1048 radially inward.

The first distance 1044 can be greater than the second distance 1048, as illustrated by the first and second abradable portions 1042, 1046 extend radially away from the step 1070, forming a step shape. Finger seals 1015 can confront the abradable element 1040. The finger seals 1015 can have varying lengths and thicknesses to accommodate the stepped or contoured shape of the first or second abradable portions 1042, 1046.

A stepped lower surface 1013 can be defined by the stepped shape or stepped spacing of the step 1070 or the abradable element 1040. It is contemplated that additional elements can be combined with the step 1070 or the step 1070 can be contoured to create the stepped lower surface 1013. It is further contemplated that the step 1070 can be multiple steps, where the multiple steps can be radially spaced.

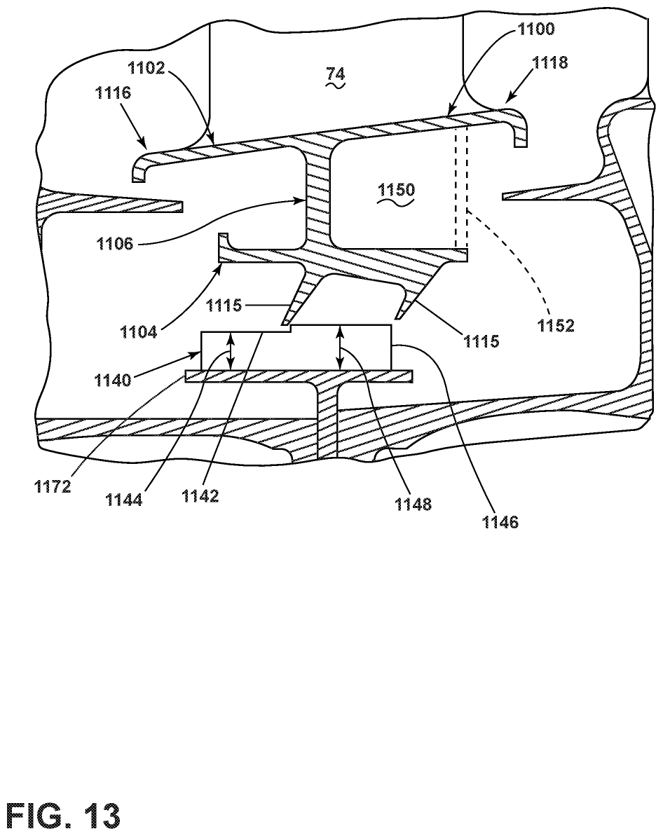

FIG. 13 another example of an inner platform 1100 coupled to the blade 74. The inner platform 700 is similar to the inner platform 100, 200, 300, 400, 500, 600, 700, 800, 900, 1000 therefore, like parts will be identified with like numerals further increased by 100, with it being understood that the description of the like parts of the inner platform 100, 200, 300, 400, 500, 600, 700, 800, 900, 1000 applies to the inner platform 1100, unless otherwise noted.

The inner platform 1100 has an upper ledge 1102, supporting the blade 74, and a lower ledge 1104 spaced from and connected to upper ledge 1102 by at least one connecting rib 1106. The inner platform 1100 has a leading edge portion 1116 and a trailing edge portion 1118.

The trailing edge portion 1118 of the inner platform 1100 or lower ledge 1104 can include an optional beam 1152 connecting the upper and lower ledges 1102, 1104. A box 1150 can be defined by the upper ledge 1102, the lower ledge 1104, the connecting rib 1106, and the beam 1152. The box 1150 can be considered to have a box beam cross section.

At least one finger seal 1115 can be carried or supported by the inner platform 1100. For example, the at least one finger seal 1115 can be coupled to the lower ledge 1104 of the inner platform 1100.

An abradable element 1140 can confront the at least one finger seal 1115. The amount of abradable material forming the abradable element 1140 can vary in thickness or composition. A first abradable portion 1142 can extend a first distance 1144 radially outward from a mounting portion 1172. A second abradable portion 1146 can extend a second distance 1148 radially outward from mounting portion 1172.

The first distance 1144 can be less than the second distance 1148. As illustrated by the first and second abradable portions 1142, 1146 extending radially away from the mounting portion 1172, forming a step-like shape. The at least one finger seal 1115 can have varying lengths and thicknesses to accommodate the stepped or contoured shape of the first or second abradable portions 1142, 1146.

While the inner platform 1100 is illustrated as substantially similar to FIG. 7, it is contemplated that any of FIGS. 3-12 can include a finger seal mounted to the inner platform at any location. The at least one finger seal can be in addition to at least one abradable element or an alternative to at least one abradable element.

Benefits associated with aspects of the disclosure herein include provide improved sealing for a rotating blade assembly, especially in a counter-rotating engine design. The inner platform design can also increase stability of the counter rotating blades axially, radially or both.

Additional benefits of the proposed inner platforms can include an increase in stability of the rotating blades or an overall reduction of the weight of the blade assembly.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the invention are provided by the subject matter of the following clauses:

1. A turbine engine comprising:

an inner rotor/stator having a longitudinal axis; and

an outer rotor circumscribing at least a portion of the inner rotor/stator and rotating about the longitudinal axis, and comprising:
a drum, and
a plurality of circumferentially arranged blade assemblies each comprising a blade terminating at a tip in an outer platform, and terminating at a root in an inner platform, with the outer platforms collectively defining an outer band secured to the drum, the inner platforms collectively forming an inner band, and with the inner platform having at least one of: a double-tail trailing edge defining a buffer cavity, a box beam cross section, or a stepped lower surface.

2. The turbine engine of any preceding clause further comprising an abradable element carried by the inner platform.

3. The turbine engine of any preceding clause wherein the abradable element comprises a honeycomb element.

4. The turbine engine of any preceding clause wherein the inner platform comprises a seat for the abradable element.

5. The turbine engine of any preceding clause wherein the inner platform has an upper ledge, supporting the blade, and a lower ledge, supporting the abradable element, spaced from and connected to upper ledge.

6. The turbine engine of any preceding clause wherein the double-tail trailing edge comprises first and second spaced fingers defining the buffer cavity.

7. The turbine engine of any preceding clause wherein the first finger is defined by a trailing edge portion of the inner platform.

8. The turbine engine of any preceding clause wherein the second finger extends away from the trailing edge portion.

9. The turbine engine of any preceding clause wherein the second finger extends axially and radially downward from the trailing edge portion.

10. The turbine engine of any preceding clause wherein the inner platform comprises a leading edge finger.

11. The turbine engine of any preceding clause wherein the leading edge finger has radially inward curve.

12. The turbine engine of any preceding clause wherein the inner platform comprises a connecting portion connecting the first finger and the leading edge finger.

13. The turbine engine of any preceding clause wherein the box beam cross section defines multiple boxes.

14. The turbine engine of any preceding clause wherein the multiple boxes are axially or radially arranged.

15. The turbine engine of any preceding clause wherein the box beam cross section has upper and lower ledges, with a connecting rib to at least partially define a box.

16. The turbine engine of any preceding clause wherein the upper ledge and the lower ledge merge to define a leading edge.

17. The turbine engine of any preceding clause wherein the upper ledge and the lower ledge diverge to define the double-tail trailing edge.

18. The turbine engine of any preceding clause wherein there are multiple connecting ribs to define multiple boxes.

19. The turbine engine of any preceding clause wherein the lower ledge further includes a seat or an abradable element that is stepped to define a stepped lower surface.

20. The turbine engine of any preceding clause wherein the lower ledge is stepped.

21. The turbine engine of any preceding clause further comprising an abradable element mounted to the lower ledge.

22. The turbine engine of any preceding clause wherein the stepped lower surface comprises a step spaced from a trailing edge portion of the inner platform.

23. The turbine engine of any preceding clause wherein the step comprises one of the double tails and the trailing edge portion forms the other of the double tails.

24. The turbine engine of any preceding clause further comprising an abradable element mounted to the step.

25. The turbine engine of any preceding clause further comprising multiple steps.

26. The turbine engine of any preceding clause wherein the multiple steps are spaced radially.

27. The turbine engine of any preceding clause wherein the inner platform has at least one finger seal confronted by an abradable portion.

What is claimed is:

1. A turbine engine comprising:
an inner rotor/stator having a longitudinal axis; and
an outer rotor circumscribing at least a portion of the inner rotor/stator and rotating about the longitudinal axis, and comprising:
a drum, and
a plurality of circumferentially arranged blade assemblies each comprising a blade terminating at a tip in an outer platform, and terminating at a root in an inner platform, with the outer platforms collectively defining an outer band secured to the drum, the inner platforms collectively forming an inner band, and with the inner platform having at least one of: a double-tail trailing edge defining a buffer cavity, a box beam cross section, or a stepped lower surface.

2. The turbine engine of claim 1 further comprising an abradable element carried by the inner platform.

3. The turbine engine of claim 2 wherein the inner platform comprises a seat for the abradable element.

4. The turbine engine of claim 3 wherein the inner platform has an upper ledge, supporting the blade, and a lower ledge, supporting the abradable element, spaced from and connected to upper ledge.

5. The turbine engine of claim 1 wherein the double-tail trailing edge comprises first and second spaced fingers defining the buffer cavity.

6. The turbine engine of claim 5 wherein the first finger is defined by a trailing edge portion of the inner platform.

7. The turbine engine of claim 6 wherein the second finger extends away from the trailing edge portion.

8. The turbine engine of claim 7 wherein the second finger extends axially and radially downward from the trailing edge portion.

9. The turbine engine of claim 5 wherein the inner platform comprises a leading edge finger.

10. The turbine engine of claim 9 wherein the leading edge finger has radially inward curve.

11. The turbine engine of claim 10 wherein the inner platform comprises a connecting portion connecting the first finger and the leading edge finger.

12. The turbine engine of claim 1 wherein the box beam cross section defines multiple boxes.

13. The turbine engine of claim 12 wherein the multiple boxes are axially or radially arranged.

14. The turbine engine of claim 1 wherein the box beam cross section has upper and lower ledges, with a connecting rib to at least partially define a box.

15. The turbine engine of claim 14 wherein the upper ledge and the lower ledge merge to define a leading edge.

16. The turbine engine of claim 15 wherein the upper ledge and the lower ledge diverge to define the double-tail trailing edge.

17. The turbine engine of claim 16 wherein there are multiple connecting ribs to define multiple boxes.

18. The turbine engine of claim 16 wherein the lower ledge further includes a seat or an abradable element that is stepped to define a stepped lower surface.

19. The turbine engine of claim 14 wherein the lower ledge is stepped.

20. The turbine engine of claim 14 further comprising an abradable element mounted to the lower ledge.
